(19) United States
(12) Patent Application Publication
(10) Pub. No.: US 2026/0162616 A1
(43) Pub. Date: Jun. 11, 2026

(54) GATE DRIVING CIRCUIT AND DISPLAY DEVICE INCLUDING THE SAME

(71) Applicant: LG Display Co., Ltd., Seoul (KR)

(72) Inventors: Seok NOH, Paju-si, Gyeonggi-do (KR); Ki Min SON, Paju-si, Gyeonggi-do (KR)

(21) Appl. No.: 18/474,101

(22) Filed: Sep. 25, 2023

(30) Foreign Application Priority Data
Jan. 27, 2023 (KR) 10-2023-0010686

(51) Int. Cl. G09G 3/3266; G09G 3/3233

(52) U.S. Cl. CPC G09G 3/3266; G09G 3/3233; G09G 2300/0819; G09G 2300/0842; G09G 2310/0286; G09G 2310/08; G09G 2330/021; G09G 2340/0435

(57) ABSTRACT

A gate driving circuit and a display device including the same are disclosed. Each of the signal transmitters of the gate driver includes: an input circuit connected to a VST node, a CLK node and including an input buffer node; an inverter circuit connected between a VDD node and a VSS node, configured to cause a second control node to be discharged during a charging period of a first control node and to cause the second control node to be charged during a discharging period of the first control node, and including a boosting node; and a buffer circuit configured to charge a first output node and a third output node according to a charging voltage of the first control node and to charge a second output node according to a charging voltage of the second control node or a charging voltage of the boosting node.

### CROSS-REFERENCE TO RELATED APPLICATION

This application claims priority to and the benefit of Korean Patent Application No. 10-2023-0010686, filed on January 27, 2023, the disclosure of which is incorporated herein by reference in its entirety.

### BACKGROUND

### Technical Field

The present disclosure relates to a gate driving circuit and a display device including the same.

### Description of the Related Art

Electroluminescent display devices are generally classified into inorganic light emitting display devices and organic light emitting display devices according to the materials of light emitting layers. Active matrix type organic light emitting display devices include organic light-emitting diodes (hereinafter referred to as “OLEDs”), which emit light by themselves, and have fast response speeds and advantages in which light emission efficiencies, brightness, and viewing angles are high.

In the organic light-emitting display devices, the OLEDs are formed in pixels. Since the organic light-emitting display devices have fast response speeds and are excellent in light emission efficiency, brightness, and viewing angle as well as being able to exhibit a black gradation in a full black color, the organic light-emitting display devices are excellent in a contrast ratio and color reproducibility.

A display panel driving circuit of an organic light-emitting display includes a data driving circuit that outputs data voltages and a gate driving circuit that outputs pulses of gate signals. The gate driving circuit may be disposed on a bezel area outside a display area where images are reproduced on the display panel.

Each of pixels of the organic light-emitting display device may include two or more switch elements that switch the data voltages and sensing electrical characteristics of the driving element and the light emitting element.

### BRIEF SUMMARY

Inventors recognized that an on/off timing of switch elements of pixels of the organic light-emitting display device may be controlled by the gate signals. The gate driving circuit may include a plurality of shift registers to individually control the switch elements constituting a pixel circuit. As a result, it is difficult to reduce the bezel area, which is a non-display area in the display panel. .

The present disclosure provides a gate driving circuit capable of reducing a non-display area in a display panel, and a display device including the gate driving circuit.

The technical features, benefits and improvements of the present disclosure are not limited to those mentioned above, and other technical features, benefits and improvements not mentioned will be clearly understood by those skilled in the art from the following description.

The gate driving circuit according to one embodiment of the present disclosure includes a plurality of signal transmitters. Each of the signal transmitters includes: an input circuit connected to a VST node to which a start pulse or a carry signal is inputted and a CLK node to which a clock is inputted, and including an input buffer node; an inverter circuit connected between a VDD node and a VSS node, configured to cause a second control node to be discharged during a charging period of a first control node and to cause the second control node to be charged during a discharging period of the first control node, and including a boosting node; and a buffer circuit configured to charge a first output node and a third output node according to a charging voltage of the first control node and to charge a second output node according to a charging voltage of the second control node or a charging voltage of the boosting node.

A pulse of a second gate signal outputted via the second output node may have a pulse having an opposite phase with respect to a pulse of a first gate signal outputted via the first output node.

A pulse of the carry signal outputted via the third output node may have a pulse that has the same phase as the pulse of the first gate signal.

The inverter circuit may include a capacitor connected between the second control node and the boosting node. A voltage of the boosting node may be charged up to a voltage higher than a voltage of the VDD node when the second control node is charged.

The inverter circuit may further include: a first transistor connected between the VDD node and the boosting node and configured to supply a voltage applied to the VDD node to the boosting node; a second transistor connected between the VDD node and the second control node and turned on when the boosting node is charged; a third transistor connected between the boosting node and the VSS node and turned on when the first control node is charged; and a fourth transistor connected between the second control node and a second VSS node and turned on when the first control node is charged.

The inverter circuit may further include: a first transistor connected between the VDD node and the boosting node and turned on when the second control node of a preceding signal transmitter is charged; a second transistor connected between the VDD node and the second control node and turned on when the boosting node is charged; a third transistor connected between the boosting node and the second control node and turned on when a voltage of the input buffer node is charged; and a fourth transistor connected between the second control node and the VSS node and turned on when the input buffer node is charged.

The buffer circuit may include: a first transistor connected between a second VDD node and the first output node and turned on when the first control node is charged; a second transistor connected between the first output node and a second VSS node and turned on when the second control node is charged; a third transistor connected between the second VDD node and the second output node and turned on when the second control node is charged; and a fourth transistor connected between the second output node and the second VSS node and turned on when the first control node charged.

The buffer circuit may further include: a fifth transistor connected between the VDD node and the third output node and turned on when the first control node is charged; a second capacitor connected between the first control node and the third output node; and a sixth transistor connected between the third output node and the VSS node and turned on when the second control node charged. A first gate-on voltage may be applied to the VDD node and the second VDD node. A gate-off voltage applied to the second VSS node may be higher than a gate-on voltage applied to the VSS node. A high voltage of the clock may be a second gate-on voltage that is lower than the first gate-on voltage.

The buffer circuit may include: a first transistor connected between a second VDD node and the first output node and turned on when the first control node is charged; a second transistor connected between the first output node and a second VSS node and turned on when the second control node is charged; a third transistor connected between the second VDD node and the second output node and turned on when the boosting node is charged; and a fourth transistor connected between the second output node and the second VSS node and turned on when the first control node charged.

The buffer circuit may further include: a fifth transistor connected between the VDD node and the third output node and turned on when the first control node is charged; a second capacitor connected between the first control node and the third output node; a sixth transistor connected between the third output node and the VSS node and turned on when the second control node charged. A first gate-on voltage may be applied to the VDD node and the second VDD node. A gate-off voltage applied to the second VSS node may be higher than a gate-on voltage applied to the VSS node. A high voltage of the clock is a second gate-on voltage that may be lower than the first gate-on voltage.

The input circuit may include: a fifth transistor connected between the VST node and the input buffer node and turned on when a voltage of the clock is a high voltage; a sixth transistor connected between the input buffer node and the first control node and turned on when the voltage of the clock is a high voltage; and a seventh transistor connected between the VDD node and the input buffer node and turned on when the first control node charged.

A display device according to one embodiment of the present disclosure includes the gate driving circuit. The display device includes a pixel circuit to which the first gate signal and the second gate signal are applied.

According to the present disclosure, it may be possible to output the gate signals having opposite phases from the signal transmitter constituting the gate driving circuit so that the number of shift registers in the gate driving circuit is reduced, thereby reducing the non-display area of the display panel.

According to the present disclosure, a pull-up transistor that raises a pulse of the second gate signal may be controlled by a voltage of the boosting node of the inverter circuit, thereby sufficiently securing a gate-source voltage of the pull-up transistor and improving a rising time of the second gate pulse. Furthermore, according to the present disclosure, it may be possible to sufficiently secure a voltage margin that allows the threshold voltage of the pull-up transistor to reach a target voltage of the second gate signal and a positive bias temperature stress (PBTS) margin even if the threshold voltage is shifted.

According to the present disclosure, low-power driving of the display device may be realized by supporting a low-speed driving mode.

The effects of the present disclosure are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other technical benefits, features, and advantages of the present disclosure will become more apparent to those of ordinary skill in the art by describing example embodiments thereof in detail with reference to the attached drawings, in which:

FIG. 1 is a block diagram illustrating a display device according to one embodiment of the present disclosure;

FIG. 2 is a cross-sectional view illustrating a cross-sectional structure of the display panel shown in FIG. 1;

FIG. 3 is a block diagram schematically illustrating a gate driver;

FIG. 4 is a block diagram schematically illustrating a configuration of a signal transmitter in a gate driver;

FIG. 5 is a circuit diagram illustrating a first embodiment of the inverter circuit shown in FIG. 4;

FIG. 6 is a circuit diagram illustrating a second embodiment of the inverter circuit shown in FIG. 4;

FIG. 7 is a waveform diagram illustrating a voltage of the boosting node shown in FIGS. 5 and 6;

FIG. 8 is a circuit diagram illustrating a first embodiment of the buffer circuit shown in FIG. 4;

FIG. 9 is circuit diagram illustrating a second embodiment of the buffer circuit shown in FIG. 4;

FIG. 10 is a diagram illustrating a connection structure of a gate driver and a pixel circuit according to a first embodiment of the present disclosure;

FIG. 11 is a diagram illustrating a connection structure of a gate driver and pixel circuits according to a second embodiment of the present disclosure;

FIG. 12 is a circuit diagram illustrating in detail a circuit of a signal transmitter according to a first embodiment of the present disclosure;

FIG. 13 is a circuit diagram illustrating in detail a circuit of a signal transmitter according to a second embodiment of the present disclosure;

FIG. 14 is a waveform diagram illustrating input/output signals of the signal transmitter shown in FIGS. 12 and 13 and voltages of the main nodes thereof;

FIG. 15 is a waveform diagram illustrating input/output signals of the signal transmitter and the voltages of its major nodes when the inverter circuit shown in FIG. 12 and 13 is replaced with the inverter circuit shown in FIG. 5;

FIG. 16 is a circuit diagram illustrating a pixel circuit according to one embodiment of the present disclosure; and

FIG. 17 is a waveform diagram illustrating waveforms of gate signals applied to the pixel circuit shown in FIG. 16.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a TFT (Thin Film Transistor). The transistors may be implemented as an oxide thin film transistor (TFT) including an oxide semiconductor, a low temperature poly silicon TFT (LTPS TFT) including a low temperature poly silicon, and the like. Hereinafter, transistors constituting the pixel circuit and the gate driving circuit will be described focusing on an example implemented with an n-channel oxide TFT, but the present disclosure is not limited thereto.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS)), since carriers are holes, a source voltage is higher than a drain voltage such that holes may flow from a source to a drain. In the p-channel transistor, since holes flow from the source to the drain, a current flows from the source to the drain. It should be noted that a source and a drain of a transistor are not fixed. For example, a source and a drain may be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage. In the description herein, a node of the circuit is charged when the voltage level of the node is switched or set to a logic “on” level and a node of a circuit is discharged when the voltage level of the node is switched or set to a logic “off” level. For example, for an nMOS transistor, a logic “on” level voltage means a logic high level voltage on a gate of the nMOS to turn on the nMOS device. A logic “off” level voltage means a logic low level voltage on a gate of an nMOS to turn off the nMOS device. For an pMOS transistor, a logic “on” level voltage means a logic low level voltage on a gate of the pMOS to turn on the pMOS device. A logic “off” level voltage means a logic high level voltage on a gate of the pMOS to turn off the pMOS device. In the description herein, the operations or configurations of a circuit are described using n-type transistors as illustrative examples. However, the disclosure is not limited to such examples. Similar circuit implementations may be achieved using p-type transistors, which are also included in the scope of the disclosure.

Hereinafter, various embodiments of the present disclosure will be described in detail with reference to the accompanying drawings.

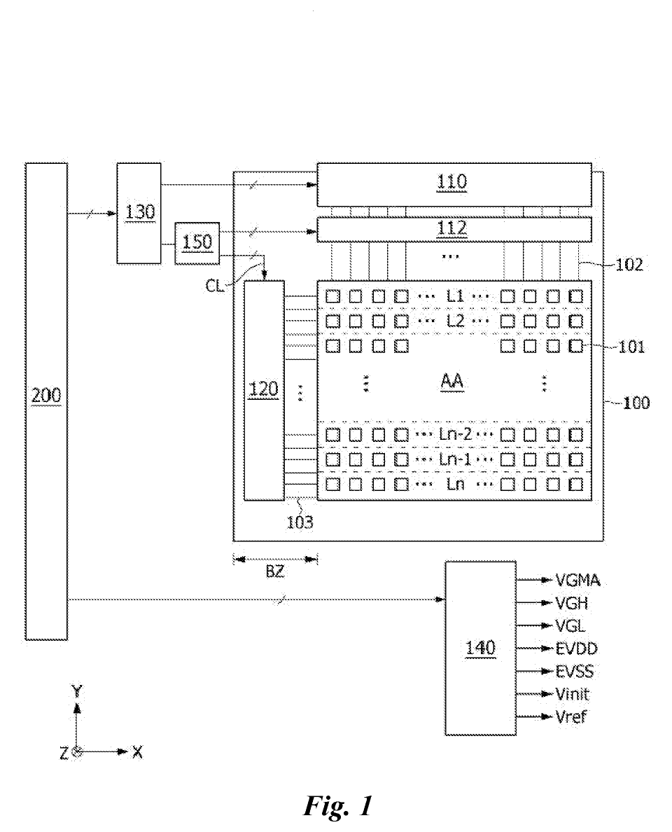

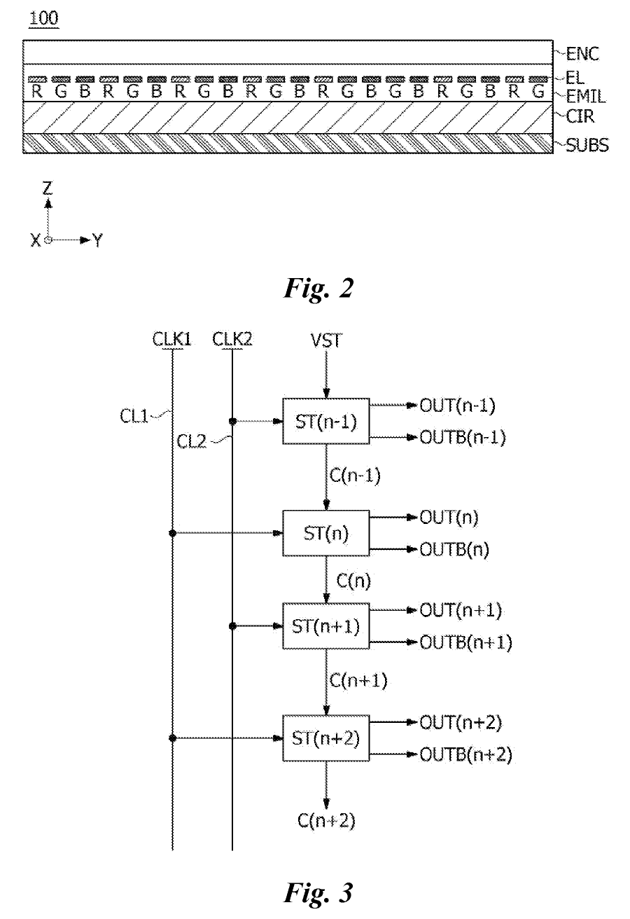

FIG. 1 is a block diagram illustrating a display device according to one embodiment of the present disclosure. FIG. 2 is a cross-sectional view illustrating a cross-sectional structure of the display panel shown in FIG. 1.

Referring to FIGS. 1 to 2, the display device according to an embodiment of the present disclosure includes a display panel 100, a display panel driving circuit for writing pixel data to pixels of the display panel 100, and a power supply 140 for generating power necessary for driving the pixels and the display panel driving circuit.

The display panel 100 may be a panel having a rectangular structure with a length in the X-axis direction, a width in the Y-axis direction, and a thickness in the Z-axis direction. A display area AA of the display panel 100 includes a pixel array for displaying an input image thereon. The pixel array includes a plurality of data lines 102, a plurality of gate lines 103 intersected with the data lines 102, and pixels arranged in a matrix form. The display panel 100 may further include power lines commonly connected to the pixels. The power lines are connected to constant voltage nodes of the pixel circuits and supply a constant voltage necessary for driving the pixels 101 to the pixels 101.

Each of the pixels 101 may be divided into a red sub-pixel, a green sub-pixel, and a blue sub-pixel for color implementation. Each of the pixels may further include a white sub-pixel. Each of the sub-pixels may be implemented with any of the pixel circuits described above. Each of the pixel circuits is connected to the data lines, the gate lines, and the power lines.

The pixels may be arranged as real color pixels and pentile pixels. A pentile pixel may realize a higher resolution than the real color pixel by driving two sub-pixels having different colors as one pixel 101 through the use of a preset pixel rendering algorithm. The pixel rendering algorithm may compensate for insufficient color representation in each pixel with the color of light emitted from an adjacent pixel.

The pixel array includes a plurality of pixel lines L1 to Ln. Each of the pixel lines L1 to Ln includes one line of pixels arranged along a line direction (X-axis direction) in the pixel array of the display panel 100. Pixels arranged in one pixel line share the gate lines 103. Sub-pixels arranged in a column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on a screen and an actual object in the background is visible. The display panel 100 may be manufactured as a flexible display panel.

The cross-sectional structure of the display panel 100 may include a circuit layer CIR, a light emitting element layer EMIL, and an encapsulation layer ENC that are stacked on a substrate SUBS, as shown in FIG. 2.

The circuit layer CIR may include a thin-film transistor (TFT) array including a pixel circuit connected to wirings such as a data line, a gate line, a power line, and the like, a de-multiplexer array 112, and a gate driver 120. The circuit layer CIR includes a plurality of metal layers insulated with insulating layers interposed therebetween, and a semiconductor material layer. All transistors formed in the circuit layer CIR may be implemented as an n-channel oxide TFT.

The light emitting element layer EMIL may include a light emitting element EL driven by the pixel circuit. The light emitting element EL may include a light emitting element of a red sub-pixel, a light emitting element of a green sub-pixel, and a light emitting element of a blue sub-pixel. The light emitting element layer EMIL may further include a light emitting element of white sub-pixel. The light emitting element layer EMIL in each of the sub-pixels may have a structure in which the light emitting element and a color filter are stacked. The light emitting elements EL in the light emitting element layer EMIL may be covered by multiple protective layers including an organic film and an inorganic film.

The encapsulation layer ENC covers the light emitting element layer EMIL to seal the circuit layer CIR and the light emitting element layer EMIL. The encapsulation layer ENC may also have a multi-insulating film structure in which an organic film and an inorganic film are alternately stacked. The inorganic film blocks permeation of moisture and oxygen. The organic film planarizes the surface of the inorganic film. When the organic layer and the inorganic layer are stacked in multiple layers, the movement path of moisture and oxygen becomes longer than that of a single layer, so that penetration of moisture and oxygen affecting the light emitting element layer EMIL may be effectively blocked.

A touch sensor layer, not shown, may be formed on the encapsulation layer ENC, and a polarizing plate or a color filter layer may be disposed thereon. The touch sensor layer may include capacitive touch sensors that sense a touch input based on a change in capacitance before and after the touch input. The touch sensor layer may include metal wiring patterns and insulating films forming the capacitance of the touch sensors. The insulating films may insulate a portion where the metal wiring patterns are intersected, and may planarize the surface of the touch sensor layer. The polarizing plate may improve visibility and contrast ratio by converting the polarization of external light reflected by metal of the touch sensor layer and the circuit layer. The polarizing plate may be implemented as a polarizer or a circular polarizer to which a linear polarizer and a phase retardation film are bonded. A cover glass may be adhered to the polarizing plate. The color filter layer may include red, green, and blue color filters. The color filter layer may further include a black matrix pattern. The color filter layer may replace the polarizing plate by absorbing a part of the wavelength of light reflected from the circuit layer and the touch sensor layer, and increase the color purity of an image reproduced in the pixel array.

The power supply 140 generates a DC voltage (or a constant voltage) necessary for driving the pixel array of the display panel 100 and the display panel driving circuit. The DC-DC converter may include a charge pump, a regulator, a buck converter, a boost converter, and the like. The power supply 140 may generate the constant voltages such as a gamma reference voltage VGMA, a gate-on voltage VGH, a gate-off voltage VGL, a pixel driving voltage EVDD, a cathode voltage EVSS, an initialization voltage Vinit, a reference voltage Vref, and the like by adjusting the level of a DC input voltage applied from a host system 200. The gamma reference voltage VGMA is supplied to a data drive 110. A gate-on voltage VGH and a gate-off voltage VGL are supplied to a level shifter 150 and a gate driver 120. The power supply 140 may output two or more gate-on voltages VGH having different voltage levels. The power supply 140 may output two or more gate-off voltages VGL having different voltage levels.

Constant voltages such as the pixel driving voltage EVDD, the cathode voltage EVSS, the initialization voltage Vinit, and the reference voltage Vref are supplied to the pixels 101 via the power lines commonly connected to the pixels 101.

The display panel driving circuit writes pixel data of an input image to the pixels of the display panel 100 in the normal driving mode under the control of the timing controller 130.

The display panel driving circuit includes the data driver 110 and the gate driver 120. The display panel driving circuit may further include a de-multiplexer array 112 disposed between the data driver 110 and the data lines 102.

The de-multiplexer array 112 sequentially supplies the data voltages outputted from channels of the data driver 110 to the data lines 102 using a plurality of de-multiplexers DEMUX. The de-multiplexer may include a multiple of switch elements disposed on the display panel 100. When the de-multiplexer is disposed between the output terminals of the data driver 110 and the data lines 102, the number of channels of the data driver 110 may be reduced. The de-multiplexer array 112 may be omitted.

The display panel driving circuit may further include a touch sensor driver for driving touch sensors. The touch sensor driver is omitted from FIG. 1. The data driver 110 and the touch sensor driver may be integrated into one drive IC (Integrated Circuit). In a mobile device or a wearable device, the timing controller 130, the power supply 140, the level shifter 150, the data driver 110, the touch sensor deriver, and the like may be integrated into one drive IC.

The display panel driving circuit may operate in a low-speed driving mode under the control of the timing controller 130. In the low-speed driving mode, power consumption of the display panel 100 and the display panel driving circuitry may be reduced, so that the display device may be driven at low power. The low-speed driving mode may be set to reduce the power consumption of the display device when input images do not change for a determined, e.g., predetermined or dynamically determined, number of frames as a result of analyzing the input images. In the low-speed driving mode, the power consumption in the display panel driving circuit and the display panel 100 may be reduced by lowering a frame frequency at which the pixel data is written to the pixels, that is, a refresh rate, when still images are inputted for a determined, e.g., predetermined or dynamically determined, time or longer. The low-speed driving mode is not limited to a case where the still images are inputted. For example, when the display device operates in a standby mode or when a user command or an input image is not inputted to the display panel driving circuit for a determined, e.g., predetermined or dynamically determined, time or longer, the display panel driving circuit may operate in the low-speed driving mode.

The data driver 110 receives pixel data of the input image received as a digital signal from the timing controller 130 and outputs a data voltage. The data driver 110 converts the pixel data of the input image into a gamma compensation voltage at each frame period in a normal driving mode using a digital-to-analogue converter (DAC) and outputs the data voltage Vdata. The data driver 110 converts the pixel data of the input image into the gamma compensated voltage to output the data voltage Vdata using the DAC only in a refresh frame in the low-speed driving mode, and stops its operation in the hold frame to not output the data voltage. In the low-speed driving mode, the pixels 101 charge a pixel data voltage in the refresh frame and maintain a previous data voltage in a hold frame.

The gamma reference voltage VGMA is divided by a voltage divider circuit into the gamma compensated voltage for each gray scale. The grayscale-wise gamma compensation voltage is provided to the DAC in the data driver 110. The data voltage Vdata is outputted through an output buffer from each of the channels of the data driver 110.

The gate driver 120 may be implemented as a gate in panel (GIP) circuit formed in the circuit layer CIR on the display panel 100 together with the TFT array of the pixel array and wirings. The gate driver 120 may be disposed on a bezel area BZ, which is non-display area of the display panel 100, or may be distributedly disposed in a pixel array in which an input image is reproduced.

The gate driver 120 may be disposed in a bezel area BZ on one or both sides of the display panel 100 with the display area of the display panel interposed therebetween and may supply gate pulses to the gate lines 103 in a single feeding or double feeding method. The gate driver 120 sequentially outputs pulses of the gate signals to the gate lines 103 under the control of the timing controller 130. The gate driver 120 may sequentially supply the gate signals to the gate lines 103 by shifting the gate signals using one or more shift register.

The timing controller 130 may receive digital video data of the input image and a timing signal synchronized therewith from the host system 200. The timing signal may include a vertical synchronization signal Vsync, a horizontal synchronization signal Hsync, a clock CLK, and a data enable signal DE. Because a vertical period and a horizontal period may be known by counting the data enable signal DE, the vertical synchronization signal Vsync and the horizontal synchronization signal Hsync may be omitted. The data enable signal DE has a cycle of one horizontal period (1H).

The host system 200 may be any of a television (TV) system, a tablet computer, a notebook computer, a navigation system, a personal computer (PC), a home theater system, a mobile device, a wearable device, or an in-vehicle system. The host system may scale an image signal from a video source to match the resolution of the display panel 100, and may transmit it to the timing controller 130 together with the timing signal.

The timing controller 130 multiplies an input frame frequency by i and controls the operation timing of the display panel driving circuit with a frame frequency of the input frame frequency × i Hz (where ‘i’ is a natural number). The input frame frequency is 60 Hz in a national television standards committee (NTSC) system and 50 Hz in a phase-alternating line (PAL) system.

The host system 200 or the timing controller 130 may vary the refresh rate or the frame frequency to match the movement or content characteristics of the input image, or may vary the refresh rate or the frame frequency based on the content of the input image.

The timing controller 130 reduces a frequency of refresh frames at which the pixel data is written to the pixels in the low-speed driving mode, compared to the normal driving mode. For example, the frequency of the refresh frames at which the pixel data is written to the pixels in the normal driving mode may be any one of frequencies greater than 60 Hz, such as 60 Hz, 120 Hz, 144 Hz, 240 Hz, and the refresh frame frequency in the low-speed driving mode may be a lower frequency than that in the normal driving mode. The timing controller 130 may set multiple hold frames after the refresh frames in order to lower the refresh rate of the pixels in the low-speed driving mode, thereby lowering the driving frequency of the display panel driving circuit and the pixels.

The timing controller 130 generates a data timing control signal for controlling the operation timing of the data driver 110, a MUX control signal for controlling the operation timing of the de-multiplexer array 112, and a gate timing control signal for controlling the operation timing of the gate driver 120, based on the timing signals received from the host system 200. The timing controller 130 synchronizes the data driver 110, the de-multiplexer array 112, the touch sensor driver, and the gate driver 120 by controlling the operation timing of the display panel driving circuit.

The MUX control signal and the gate timing control signal outputted from timing controller 130 may be inputted to the de-multiplexer array 112 and the gate driver 120 through the level shifter 150. The level shifter 150 may receive the gate timing control signal to generate a start pulse and a shift clock. The start pulse and the shift clock outputted from the level shifter 150 may swing between the gate-on voltage VGH and the gate-off voltage VGL and may be inputted to the shift register of the gate driver 120 via clock lines CL.

FIG. 3 is a block diagram schematically illustrating the gate driver.

Referring to FIG. 3, the gate driver 120 outputs first and second gate signals [OUT(n-1) to OUT(n+2) and OUTB(n-1) to OUTB(n+2)] using a shift register. The shift register includes signal transmitters [ST(n-1) to ST(n+2)] that are connected to in cascade.

The signal transducers [ST(n-1) to ST(n+2)] are connected to the clock lines CL1 and CL2 to receive the shift clocks CLK1 and CLK2. The signal transmitters [ST(n-1) to ST(n+2)] are connected in cascade by carry lines to which carry signals [C(n-1) to C(n+2)] are applied.

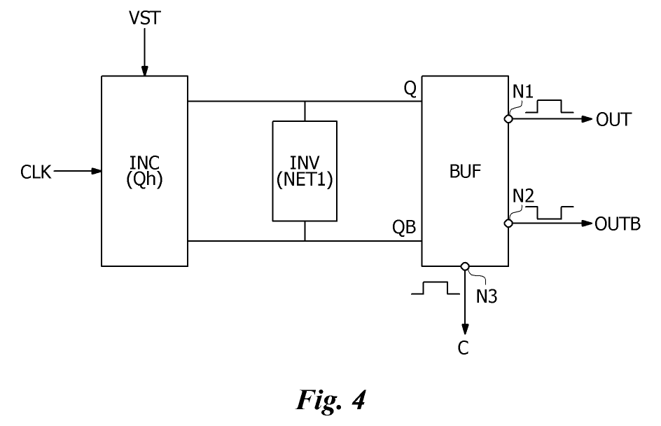

Each of the signal transmitters [ST(n-1) to ST(n+2)] has a VST node to which a start pulse VST or the carry signal [C(n-1) to C(n+2)] is inputted, a CLK node to which the shift clocks CLK1 and CLK2 are inputted, a first output node from which first gate signals [OUT(n-1) to OUT(n+2)] are outputted, a second output node from which second gate signals [OUTB(n-1) to OUTB(n+2)] are outputted, and a third output node from which the carry signals [C(n-1) to C(n+2)] are outputted. Each of the signal transmitters [ST(n-1) to ST(n+2)] further includes a first control node Q, a second control node QB, and a boosting node NET1 of the inverter circuit INV, as shown in FIG. 4.

The pulses of the second gate signals [OUTB(n-1) to OUTB(n+2)] have an inverted phase with respect to pulses of the first gate signals [OUT(n-1) to OUT(n+2)]. The pulses of the carry signals [C(n-1) to C(n+2)] have the same phase as the pulses of the first gate signals [OUT(n-1) to OUT(n+2)].

The start pulse VST is generally inputted to a first signal transmitter. In the example of FIG. 3, an (n-1)^{th} signal transmitter [ST(n-1)] may be the first signal transmitter. The shift clocks [CLK1 and CLK2] may be 2-phase clocks whose phases are inverted from each other, but are not limited thereto. For example, the shift clocks may be N-phase clocks whose phases are sequentially shifted (where N is a positive integer greater than or equal to 4).

The signal transmitters [ST(n) to ST(n+2)] connected in cascade to the (n-1)^{th} signal transmitter [ST(n-1)] are driven when receiving the carry signals [C(n-1) to C(n+2)] as the start pulse from their preceding signal transmitters. The signal transmitters [ST(n-1) to ST(n+2)] may output the first gate signals [OUT(n-1) to OUT(n+2)] via their first output nodes, the second gate signals [OUTB(n-1) to OUTB(n+2)] via their second output nodes, and the carry signals [C(n-1) to C(n+2)] via their third output nodes, respectively.

The (n-1)^{th} signal transmitter [ST(n-1)] receives the start pulse VST and the second shift clock CLK2 as inputs, and simultaneously outputs the first and second gate signals [OUT(n-1) and OUTB(n-1)], whose phases are inverted from each other, and the (n-1)^{th} carry signal [C(n-1)]. Subsequently, the n^{th} signal transmitter [ST(n)] receives the pulse of the (n-1)^{th} carry signal [C(n-1)] and the first shift clock CLK1 as inputs, and simultaneously outputs the first and second gate signals [OUT(n) and OUTB(n)], whose phases are inverted from each other, and the n^{th} carry signal [C(n)]. Subsequently, the (n+1)^{th} signal transmitter [ST(n+1)] receives the pulse of the n^{th} carry signal [C(n)] and the second shift clock CLK2 as inputs, and simultaneously outputs the first and second gate signals [OUT(n+1) and OUTB(n+1)], whose phases are inverted from each other, and the (n+1)^{th} carry signal [C(n+1)]. Next, the (n+2)^{th} signal transmitter [ST(n+2)] receives the pulse of the (n+1)^{th} carry signal [C(n+1)] and the first shift clock CLK1 as inputs, and simultaneously outputs the first and second gate signals [OUT(n+2) and OUTB(n+2)], whose phases are inverted from each other, and the (n+2)^{th} carry signal [C(n+2)].

FIG. 4 is a schematic block diagram illustrating a configuration of the signal transmitter in the gate driver 120.

Referring to FIG. 4, each of the signal transmitters [ST(n-1) to ST(n+2)] includes an input circuit INC, an inverter circuit INV, and a buffer circuit BUF.

The input circuit INC is connected to the VST node in which the start pulse or the carry signal is inputted, to a CLK node to which the clock is inputted, to a first control node Q, and to the inverter circuit INV. The input circuit INC charges and discharges the first control node Q in response to input signals inputted via the VST node and the CLK node. The input circuit INC includes an input buffer node Qh.

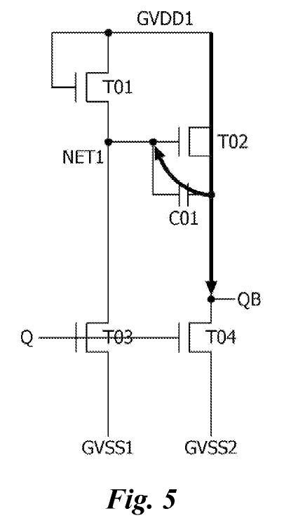

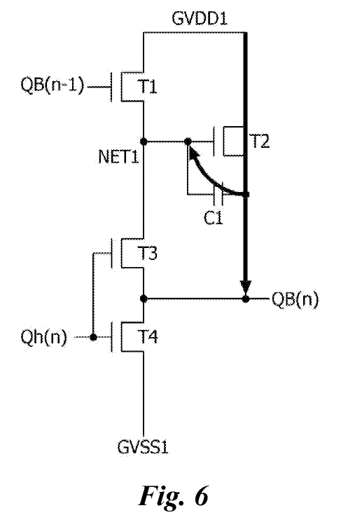

The inverter circuit INV is connected between a VDD node and a VSS node to discharge a second control node QB when the first control node Q is charged, and to charge the second control node QB when the first control node Q is discharged. The inverter circuit INV may be implemented as the circuits illustrated in FIGS. 5 and 6.

The inverter circuit INV includes a boosting node NET1. A voltage of the boosting node NET1 is charged up to a voltage higher than a voltage of the VDD node when the second control node QB is charged by a capacitor connected between the second control node QB and the boosting node NET1.

The buffer circuit BUF outputs a first gate signal OUT via a first output node N1, and outputs a second gate signal OUTB via a second output node N2. The buffer circuit BUF outputs a carry signal C via a third output node N3.

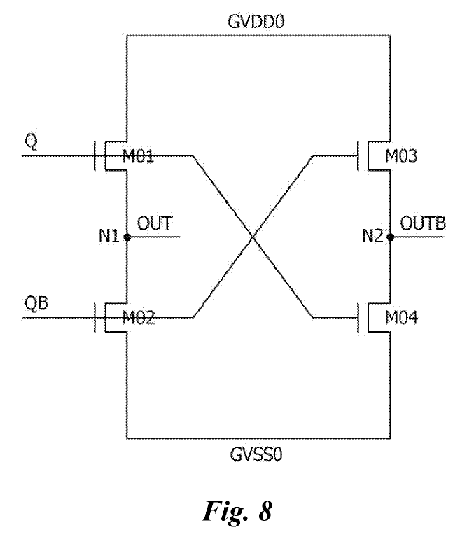

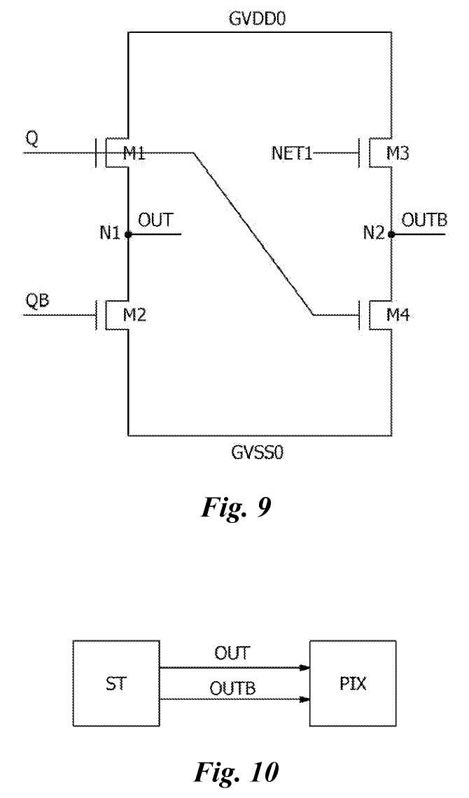

The buffer circuit BUF charges the first output node N1 and the third output node N3 according to a charging voltage (or a high voltage) of the first control node Q, and charges the second output node N2 according to a charging voltage of the second control node QB or a charging voltage of the boosting node NET1 of the inverter circuit INV. The buffer circuit BUF discharges the first output node N1 and the third output node N3 according to the charging voltage of the second control node QB, and discharges the second output node N2 according to the charging voltage of the first control node Q. The buffer circuit BUF may be implemented as the circuit shown in FIG. 8 or FIG. 9.

FIG. 5 is a circuit diagram illustrating a first embodiment of the inverter circuit shown in FIG. 4.

Referring to FIG. 5, the inverter circuit INV includes first to fourth transistors T01 to T04 and a capacitor C01.

A first transistor T01 is connected between the VDD node GVDD1 and the boosting node NET1 to supply the gate-on voltage applied to the VDD node GVDD1 to the boosting node NET1. The first transistor T01 includes a gate electrode and a first electrode connected to the VDD node GVDD1, and a second electrode connected to the boosting node NET1.

A second transistor T02 is connected between the VDD node GVDD1 and the second control node QB and is turned on when the boosting node NET1 is charged or set to a logic “on” level. The capacitor C01 is connected between the boosting node NET1 and the second control node QB. When a gate-on voltage VGH1 is applied to the second control node QB, the voltage of the boosting node NET1 is boosted by the capacitor C01 to a voltage higher than the gate-on voltage applied to the VDD node, resulting in the second transistor T02 being turned on. When the second transistor T02 is turned on, the second control node QB charges up to the gate-on voltage. The second transistor T02 includes a gate electrode connected to the boosting node NET1, a first electrode connected to the VDD node GVDD1, and a second electrode connected to the second control node QB.

A third transistor T03 is connected between the boosting node NET1 and a VSS node GVSS1 to turn on when the first control node Q is charged . The gate-off voltage VGL is applied to the VSS node GVSS1. When the voltage of the first control node Q is charged above the threshold voltage of the third transistor T03, the third transistor T03 is turned on to connect the boosting node NET1 to the VSS node GVSS1. When the third transistor T03 is turned on, the voltage of the boosting node NET1 is discharged up to the gate-off voltage, resulting in the second transistor T02 being turned off. The third transistor T03 includes a gate electrode connected to the first control node Q, a first electrode connected to the boosting node NET1, and a second electrode connected to the VSS node GVSS1.

A fourth transistor T04 is connected between the second control node QB and a VSS node GVSS2. A gate-off voltage VGL2 is applied to the VSS node GVSS2. When the voltage of the first control node Q is charged above the threshold voltage of the fourth transistor T04, the fourth transistor T04 is turned on and the second control node QB is connected to the VSS node GVSS2. When the second control node QB is connected to the VSS node GVSS2, the voltage of the second control node QB is discharged up to the gate-off voltage. The fourth transistor T04 includes a gate electrode connected to the first control node Q, a first electrode connected to the second control node QB, and a second electrode connected to the VSS node GVSS2.

FIG. 6 is a circuit diagram illustrating a second embodiment of the inverter circuit shown in FIG. 4.

Referring to FIG. 6, the inverter circuit INV includes first to fourth transistors T1 to T4, and a capacitor C1. The inverter circuit INV shown in FIG. 6 is an example of an inverter circuit in the n^{th} signal transmitter [ST(n)].

A first transistor T1 is connected between a VDD node GVDD1 and a boosting node NET1 and is turned on when a second control node [QB(n-1)] of a preceding transmitter is charged. A preceding transmitter may be, but is not limited to, the (n-1)^{th} transmitter [ST(n-1)]. When the first transistor T1 is turned on, the VDD node GVDD1 may be connected to the boosting node NET1 to charge the boosting node NET1. The first transistor T1 includes a gate electrode connected to the second control node [QB(n-1)] of the (n-1)^{th} signal transmitter [ST(n-1)], a first electrode connected to the VDD node GVDD1, and a second electrode connected to the boosting node NET1.

A second transistor T2 is connected between the VDD node GVDD1 and the second control node [QB(n)] of the n^{th} signal transmitter [ST(n)] and is turned on when the boosting node NET1 is charged. The capacitor C1 is connected between the boosting node NET1 and the second control node [QB(n)] of the n^{th} signal transmitter [ST(n)]. When the gate-on voltage from the VDD node GVDD1 is applied to the second control node [QB(n)] of the n^{th} signal transmitter [ST(n)], the voltage of the boosting node NET1 is boosted by the capacitor C1 to a voltage higher than the gate-on voltage, resulting in the second transistor T2 being turned on. When the second transistor T2 is turned on, the second control node [QB(n)] of the n^{th} signal transmitter [ST(n)] is charged up to the gate-on voltage. The second transistor T2 includes a gate electrode connected to the boosting node NET1, a first electrode connected to the VDD node GVDD1, and a second electrode connected to the second control node [QB(n)] of the n^{th} signal transmitter [ST(n)].

A third transistor T3 is connected between the boosting node NET1 and the second control node [QB(n)] of the n^{th} signal transmitter [ST(n)], and is turned on when an input buffer node [Qh(n)] is charged. When the third transistor T3 is turned on, the boosting node NET1 is connected to the second control node [QB(n)] of the n^{th} signal transmitter [ST(n)]. When the third transistor T3 is turned on, the voltage of the boosting node NET1 is discharged up to the gate-off voltage, resulting in the second transistor T2 being turned off. The third transistor T3 includes a gate electrode connected to the input buffer node [Qh(n)] of the n^{th} signal delivery part [ST(n)], a first electrode connected to the boosting node NET1, and a second electrode connected to the second control node [QB(n)] of the n^{th} signal transmitter [ST(n)].

The third and fourth transistors T3 and T4 may be turned on/off simultaneously according to the voltage of the input buffer node [Qh(n)]. A fourth transistor T4 is connected between the second control node QB and the VSS node GVSS1 and is turned on when the input buffer node [Qh(n)] is charged. When the fourth transistor T4 is turned on, the second control node [QB(n)] of the n^{th} signal transmitter [ST(n)] is connected to the VSS node GVSS1. When the second control node [QB(n)] is connected to the VSS node GVSS1, a voltage of the second control node [QB(n)] is discharged up to the gate-off voltage applied to the VSS node GVSS1. The fourth transistor T4 includes a gate electrode connected to the input buffer node [Qh(n)] of the nth signal transmitter [ST(n)], a first electrode connected to the second control node [QB(n)], and a second electrode connected to the VSS node GVSS1.

The input buffer node [Qh(n)] may be charged when a voltage of the shift clock applied to the CLK node is the gate-on voltage and a voltage of the start pulse or the carry signal applied to the VST node is the gate-on voltage.

In the case of the signal transmitter circuit to which the inverter circuit INV shown in FIG. 5 is applied, a low voltage level of the first and second control nodes Q and QB may be a voltage of the second VSS node GVSS2. In the case of the signal delivery circuit to which the inverter circuit INV illustrated in FIG. 6 is applied, the low voltage level of the first and second control nodes Q and QB may be a voltage of the first VSS node GVSS1.

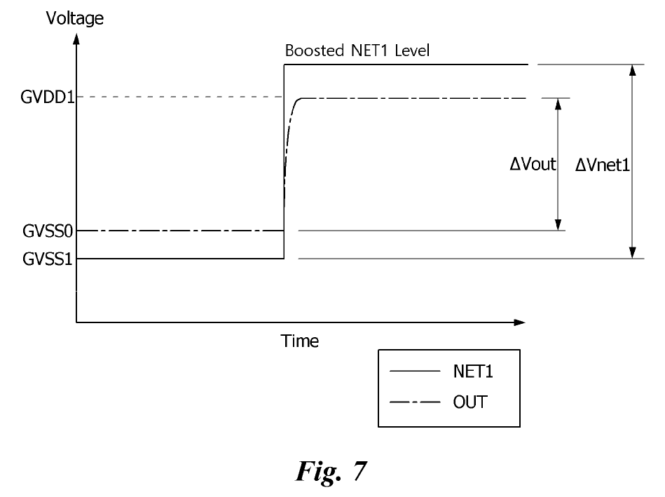

FIG. 7 is a waveform diagram illustrating the voltage of the boosting node NET1.

Referring to FIG. 7, the boosting node NET1 of the inverter circuit INV is connected to the second control node QB with the capacitors C01 and C1 interposed therebetween, and its voltage is boosted when the second control node QB is charged. In this case, a high voltage of the boosting node NET1 is boosted up to a voltage (VGH1+αV) that is higher than a voltage of the VDD node GVDD1. A low voltage when the boosting node NET1 is discharged is the voltage of the VSS node GVSS1. Therefore, a voltage ΔVnet1 of the boosting node NET1 swings between the voltage of the VDD node GVDD1 and the voltage of the VSS node GVSS1.

A high voltage of the gate signals [OUT(n-1) to OUT(n+2) and OUTB(n-1) to OUTB(n+2)] may be lower than a high voltage of the boosting node NET1, and a low voltage of the gate signals [OUT(n-1) to OUT(n+2) and OUTB(n-1) to OUTB(n+2)] may be higher than a low voltage of the boosting node NET1. In this case, as shown in FIG. 7, a voltage Δout of the gate signals [OUT(n-1) to OUT(n+2) and OUTB(n-1) to OUTB(n+2)] has a swing width lower than the voltage ΔVnet1 of the boosting node NET1. For example, the high voltage of the gate signals [OUT(n-1) to OUT(n+2) and OUTB(n-1) to OUTB(n+2)] may be the voltage of the VDD node, and the low voltage of the gate signals [OUT(n-1) to OUT(n+2) and OUTB(n-1) to OUTB(n+2)] may be the voltage of the VSS node GVSS0. The gate-off voltage VGL1 applied to the VSS node GVSS0 may be a voltage higher than the gate-off voltage VGL2 applied to the VSS node GVSS1. In FIG. 7, “OUT” denotes the first gate signals [OUT(n-1) to OUT(n+2)].

FIG. 8 is a circuit diagram illustrating a first embodiment of the buffer circuit BUF shown in FIG. 4.

Referring to FIG. 8, the buffer circuit BUF includes at least first to fourth transistors M01 to M04. The buffer circuit BUF may further include transistors that output pulses of the carry signals [C(n-1) to C(n+2)].

A first transistor M01 is connected between a VDD node GVDD0 and a first output node N1 and is controlled according to a voltage of a first control node Q. The gate-on voltage VGH1 is applied to the VDD node GVDD0. The first transistor M01 is a pull-up transistor that is turned on when the first control node Q is charged and when the voltage of the first control node Q is a high voltage to charge the first output node N1 up to the gate-on voltage VGH1. A high voltage of the first control node Q may be a voltage higher than a gate-on voltage, that is, VGH2+αV. Here, α is a value greater than 0. The first transistor M01 includes a gate electrode connected to the first control node Q, a first electrode connected to the VDD node GVDD0, and a second electrode connected to the first output node N1.

A second transistor M02 is connected between the first output node N1 and a VSS node GVSS0 and is controlled according to a voltage of a second control node QB. The second transistor M02 is a pull-down transistor that is turned on when a second control node QB is charged and when the voltage of the second control node QB is a high voltage to discharge the first output node N1 by connecting the first output node N1 to a VSS node GVSS0 to which the gate-off voltage VGL1 is applied. A high voltage of the second control node QB may be the gate-on voltage VGH1. The second transistor M02 includes a gate electrode connected to the second control node QB, a first electrode connected to the first output node N1, and a second electrode connected to the VSS node GVSS0.

A third transistor M03 is connected between the VDD node GVDD0 and a second output node N2 and is controlled according to the voltage of the second control node QB. The third transistor M03 is a pull-up transistor that is turned on when the voltage of the second control node QB is high to charge the second output node N2 to the gate-on voltage VGH1. The third transistor M03 includes a gate electrode connected to the second control node QB, a first electrode connected to the VDD node GVDD0, and a second electrode connected to the second output node N2.

A fourth transistor M04 is connected between the second output node N2 and the VSS node GVSS0 and is controlled according to the voltage of the first control node Q. The fourth transistor M04 is a pull-down transistor that is turned on when the voltage of the first control node Q is a high voltage to discharge the second output node N2 by connecting the second output node N2 to the VSS node GVSS0. The fourth transistor M04 includes a gate electrode connected to the first control node Q, a first electrode connected to the second output node N2, and a second electrode connected to the VSS node GVSS0.

FIG. 9 is a circuit diagram illustrating a second embodiment of the buffer circuit BUF shown in FIG. 4.

Referring to FIG. 9, the buffer circuit BUF includes at least first to fourth transistors M1 to M4. The buffer circuit BUF may further include transistors that output pulses of the carry signals [C(n-1) to C(n+2)].

A first transistor M1 is connected between a VDD node GVDD0 and a first output node N1 and is controlled according to a voltage of a first control node Q. The first transistor M1 is turned on when the first control node Q is charged and the voltage of the first control node Q is a high voltage. When the first transistor M1 is turned on, the first output node N1 is charged up to the gate-on voltage VGH1. The first transistor M1 includes a gate electrode connected to the first control node Q, a first electrode connected to the VDD node GVDD0, and a second electrode connected to the first output node N1.

A second transistor M2 is connected between the first output node N1 and a VSS node GVSS0 and is controlled according to a voltage of a second control node QB. The second transistor M2 is turned on when the second control node QB is charged and the voltage of the second control node QB is a high voltage. When the second transistor M2 is turned on, the second control node QB is discharged to the gate-off voltage VGL1. The second transistor M2 includes a gate electrode connected to the second control node QB, a first electrode connected to the first output node N1, and a second electrode connected to the VSS node GVSS0.

A third transistor M3 is connected between the VDD node GVDD0 and a second output node N2 and is controlled according to a voltage of the boosting node NET1 of the inverter circuit INV. The third transistor M3 is turned on when the voltage of the boosting node NET1 of the inverter circuit INV is a high voltage. When the third transistor M3 is turned on, the second output node N2 is charged up to the gate-on voltage VGH1. The third transistor M3 includes a gate electrode connected to the boosting node NET1 of the inverter circuit INV, a first electrode connected to the VDD node GVDD0, and a second electrode connected to the second output node N2.

A fourth transistor M4 is connected between the second output node N2 and a VSS node GVSS0 and is controlled according to the voltage of the first control node Q. The fourth transistor M4 is turned on when the voltage of the first control node Q is the high voltage. When the fourth transistor M4 is turned on, the second output node N2 is discharged up to the gate-off voltage VGL1. The fourth transistor M4 includes a gate electrode connected to the first control node Q, a first electrode connected to the second output node N2, and a second electrode connected to the VSS node GVSS0.

The voltage of the first control node Q and the voltage of the second control node QB have an opposite voltage by the inverter INV. Therefore, the waveforms of the first gate signal OUT and the second gate signal OUTB outputted from the buffer circuit BUF shown in FIGS. 8 and 9 are inverted with respect to each other.

In the inverter INV, the high voltage of the boosting node NET1 is a voltage higher than the high voltage of the second control node QB. As a result, for the buffer circuit BUF shown in FIG. 9, a larger gate-source voltage Vgs of the third transistor M3 may be secured, and the rising time of the second gate signal OUTB may be accelerated. Furthermore, when the third transistor M3 is controlled by the voltage of the boosting node NET1, it may be possible to sufficiently secure a voltage margin that allows the high voltage of the second gate signal OUTB to reach a target voltage level even if the threshold voltage of the third transistor M3 is shifted to a higher voltage due to the stress accumulation of the third transistor M3.

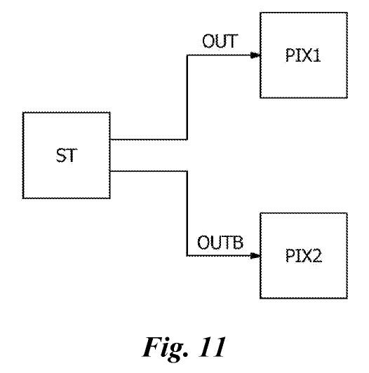

FIG. 10 is a diagram illustrating a connection structure of a gate driver and a pixel circuit according to a first embodiment of the present disclosure. FIG. 11 is a diagram illustrating a connection structure of a gate driver and pixel circuits according to a second embodiment of the present disclosure.

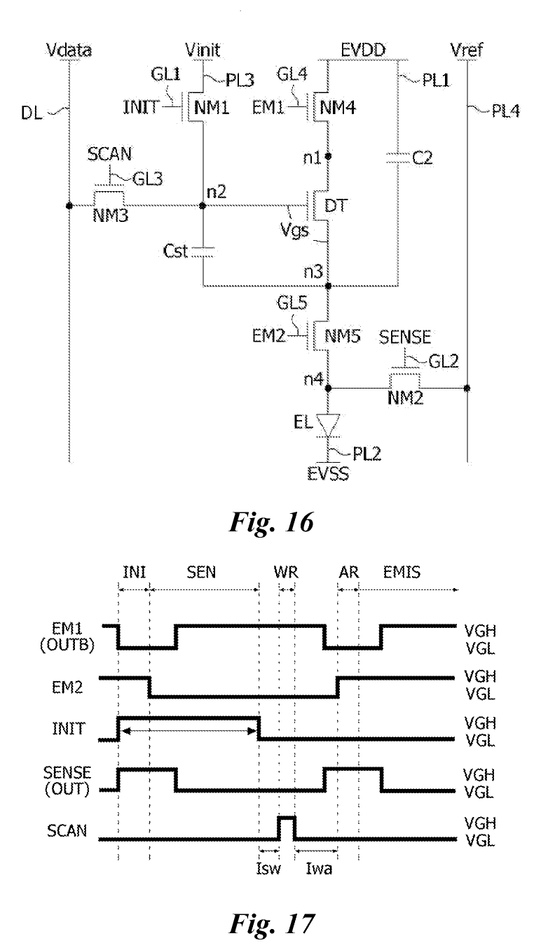

Referring to FIG. 10, the pulses of the first and second gate signals OUT and OUTB outputted from the signal transmitter ST may be applied to a pixel circuit PIX. For example, in FIGS. 16 and 17, a second scan signal SENSE and a first emission control signal EM1 applied to a pixel circuit on an n^{th} pixel line may be generated as pulses having opposite phases. In this case, the second scan signal SENSE applied to the pixel circuit on the nth pixel line may be the first gate signal OUT, and the first emission control signal EM1 applied to the pixel circuit may be the second gate signal OUTB.

Referring to FIG. 11, a pulse of the first gate signal OUT outputted from a signal transmitter ST may be applied to a first pixel circuit PIX1, and a pulse of the second gate signal OUTB may be applied to a second pixel circuit PIX2. The pixel line on which the first pixel circuit PIX1 is disposed and the pixel line on which the second pixel circuit PIX2 is disposed may be different from each other. For example, in FIGS. 16 and 17, a first emission control signal EM1 applied to a pixel circuit on an nth pixel line and a second scan signal SENSE applied to a pixel circuit of an (n+1)th pixel line may be generated as pulses having opposite phases. In this case, the first emission control signal EM1 applied to the pixel circuit on the nth pixel line may be the second gate signal OUTB, and the second scan signal SENSE applied to the pixel circuit on the (n+1)th pixel line may be the first gate signal OUT.

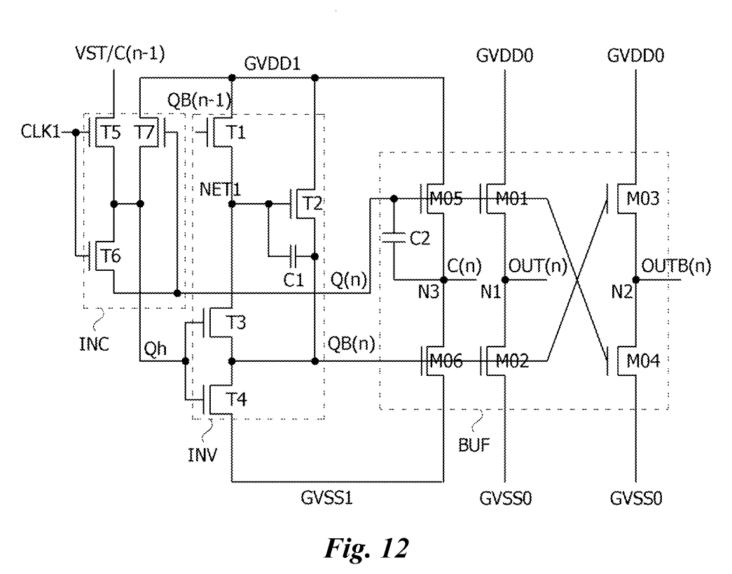

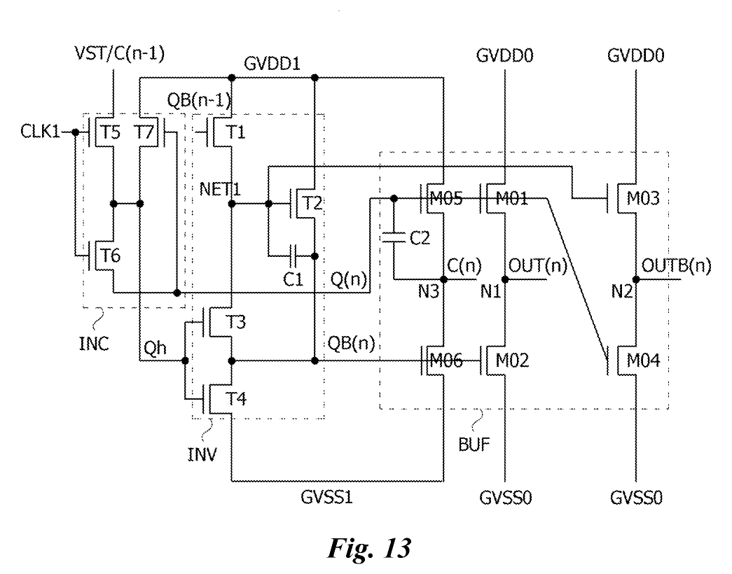

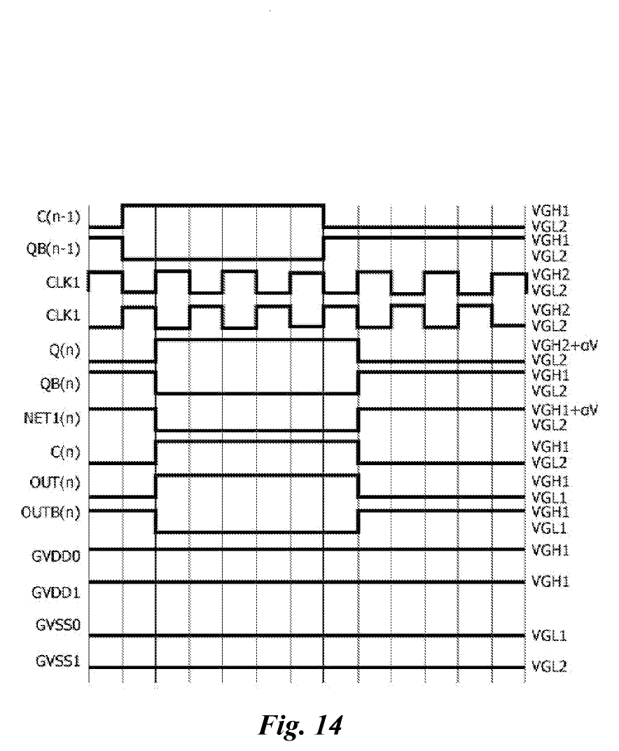

FIG. 12 is a circuit diagram illustrating in detail a circuit of a signal transmitter according to a first embodiment of the present disclosure. FIG. 13 is a circuit diagram illustrating in detail a circuit of a signal transmitter according to a second embodiment of the present disclosure. FIG. 14 is a waveform diagram illustrating input/output signals of the signal transmitter shown in FIGS. 12 and 13 and voltages of its main nodes. The circuit of the transmitter of the present disclosure is not limited to the circuit shown in FIGS. 12 and 13.

Referring to FIG. 12, each of the signal transmitters include power nodes to which constant voltages are applied, for example, VDD nodes GVDD1 and GVDD0 to which the gate-on voltage VGH is applied, and VSS nodes GVSS0 and GVSS1 to which the gate-off voltage VGL is applied. The gate-on voltage VGH having the same voltage level or the gate-on voltage VGH having different voltage levels may be applied to the VDD nodes GVDD1 and GVDD0. The gate-off voltage VGL having the same voltage level or the gate-off voltage VGL having different voltage levels may be applied to the VSS nodes GVSS0 and GVSS1. In one example, the voltage of the first and second VDD nodes GVDD1 and GVDD0 may be the first gate-on voltage VGH1. A voltage of a first VSS node GVSS1 may be the first gate-off voltage VGL1, and a voltage of the second VSS node GVSS0 may be the second gate off voltage VGL2.

Each of the signal transmitters further includes a VST node to which a start pulse VST or a carry signal [C(n-1)] from a preceding signal transmitter [ST(n-1)] is inputted, a CLK node to which shift clocks CLK1 and CLK2 are inputted, a first output node N1 from which a first gate signal [OUT(n)] is outputted, a second output node N2 from which a second gate signal [OUTB(n)] is outputted, and a third output node N3 from which a carry signal [C(n)] is outputted.

For an n^{th} signal transmitter [ST(n)], a first shift clock CLK1 may be inputted to the CLK node, but is not limited thereto. A voltage of the shift clocks CLK1 and CLK2 swings between the second gate-on voltage VGH2 and the second gate-off voltage VGL2.

Voltages of first and second gate signals [OUT(n) and OUTB(n)] and carry signals [C(n-1) and C(n)] swing between the first gate-on voltage VGH1 and the second gate off voltage VGL2. In the inverter circuit INV, a voltage of the boosting node [NET1(n)] swings between a voltage (VGH1+αV) higher than the first gate-on voltage VGH1 and the second gate-off voltage VGL2.

An input circuit INC of the nth signal transducer [ST(n)] may include fifth to seventh transistor T5, T6, and T7.

A fifth transistor T5 is connected between the VST node and an input buffer node Qh and is turned on when a voltage of the shift clock CLK1 is a high voltage VGH2 to charge the input buffer node Qh up to a voltage of the VST node. The carry signal [C(n-1)] from a preceding transmitter may be applied to the VST node. The fifth transistor T5 includes a gate electrode connected to the CLK node where the shift clock CLK1 is applied, a first electrode connected to the VST node, and a second electrode connected to the input buffer node Qh.

A sixth transistor T6 is connected between the input buffer node Qh and a first control node [Q(n)] and is turned on when the voltage of the shift clock CLK1 is the high voltage VGH2 to charge the first control node [Q(n)]. The sixth transistor T6 includes a gate electrode connected to the CLK node, a first electrode connected to the input buffer node Qh, and a second electrode connected to the first control node [Q(n)].

The fifth and sixth transistors T5 and T6 are connected in a two transistor series (TTS) structure connected in series. The TTS structure has little leakage current in the off state of the transistors T5 and T6.

A seventh transistor T7 is connected between a first VDD node GVDD1 and the input buffer node Qh, and is turned on when the first control node [Q(n)] is charged to connect the first VDD node GVDD1 to which the gate-on voltage VGH1 is applied to the input buffer node Qh. The seventh transistor T7 includes a gate electrode connected to the first control node [Q(n)], a first electrode connected to the first VDD node GVDD1, and a second electrode connected to the input buffer node Qh.

The inverter circuit INV may be implemented as the circuit illustrated in FIG. 5, or as the circuit illustrated in FIG. 6. In the examples of FIGS. 12 and 13, the inverter circuit INV is illustrated as the circuit illustrated in FIG. 6, but may be replaced with the circuit illustrated in FIG. 5.

The inverter circuit INV includes first to fourth transistors T1 to T4, and a first capacitor C1. A first transistor T1 includes a gate electrode connected to a second control node [QB(n-1)] of a preceding transmitter [ST(n-1)], a first electrode connected to a first VDD node GVDD1, and a second electrode connected to a boosting node NET1. A second transistor T2 includes a gate electrode connected to the boosting node NET1, a first electrode connected to the first VDD node GVDD1, and a second electrode connected to a second control node [QB(n)]. A third transistor T3 includes a gate electrode connected to an input buffer node Qh, a first electrode connected to the boosting node NET1, and a second electrode connected to the second control node [QB(n)]. A fourth transistor T4 includes a gate electrode connected to the input buffer node Qh, a first electrode connected to the second control node [QB(n)], and a second electrode connected to a first VSS node GVSS1.

A buffer circuit BUF may be implemented as the circuit illustrated in FIG. 8. The buffer circuit BUF includes first to sixth transistors M01 to M06, and a second capacitor C2.

A first transistor M01 includes a gate electrode connected to the first control node [Q(n)], a first electrode connected to the second VDD node GVDD0, and a second electrode connected to the first output node N1. A second transistor M02 includes a gate electrode connected to the second control node [QB(n)], a first electrode connected to the first output node N1, and a second electrode connected to the second VSS node GVSS0. A third transistor M03 includes a gate electrode connected to the second control node [QB(n)], a first electrode connected to the second VDD node GVDD0, and a second electrode connected to the second output node N2. A fourth transistor M04 includes a gate electrode connected to the first control node [Q(n)], a first electrode connected to the second output node N2, and a second electrode connected to the second VSS node GVSS0.

A fifth and sixth transistors M05 and M06 are turned on/off according to the voltages of the first and second control nodes [Q(n) and QB(n)] to charge/discharge the third output node N3 to output a pulse of the carry signal [C(n)] via the third output node N3. The fifth transistor M05 is connected between the first VDD node GVDD1 and the third output node N3 and is turned on when the first control node [Q(n)] is charged. The fifth transistor M05 is a pull-up transistor that is turned on when the first control node [Q(n)] is boosted to a voltage (VGH2+αV) higher than the gate-on voltage to charge the third output node N3 up to the gate-on voltage VGH1. The fifth transistor M05 includes a gate electrode connected to the first control node [Q(n)], a first electrode connected to the first VDD node GVDD1, and a second electrode connected to the third output node N3.

The second capacitor C2 is connected between the first control node [Q(n)] and the third output node N3. The second capacitor C2 boosts the voltage of the first control node [Q(n)] to the voltage VGH1 of the first VDD node GVDD1 when the fifth transistor M05 is turned on.

The sixth transistor M06 is connected between the third output node N3 and the first VSS node GVSS1 and is turned on when the second control node [QB(n)] is charged. The sixth transistor M06 is a pull-down transistor that is turned on when a voltage of the second control node [QB(n)] is the gate-on voltage VGH1 to discharge the third output node N3 by connecting the third output node N3 to the first VSS node GVSS1. The sixth transistor M06 includes a gate electrode connected to the second control node [QB(n)], a first electrode connected to the third output node N3, and a second electrode connected to the first VSS node GVSS1.

In the circuit of the signal transmitter shown in FIG. 13, the components that are substantially the same as the circuit shown in FIG. 12 are designated with the same reference numerals and a detailed description thereof will be omitted.

Referring to FIG. 13, an input circuit INC of the nth signal transmitter [ST(n)] may include transistors T5, T6, and T7. An inverter circuit INV may include first to fourth transistors T1 to T4, and a first capacitor C1.

A buffer circuit BUF may be implemented as the circuit illustrated in FIG. 9. The buffer circuit BUF includes first to sixth transistors M01 to M06, and a second capacitor C2.

A first transistor M01 includes a gate electrode connected to the first control node [Q(n)], a first electrode connected to the second VDD node GVDD0, and a second electrode connected to the first output node N1. A second transistor M02 includes a gate electrode connected to the second control node [QB(n)], a first electrode connected to the first output node N1, and a second electrode connected to the second VSS node GVSS0. A third transistor M03 includes a gate electrode connected to a boosting node NET1 of the inverter circuit INV, a first electrode connected to the second VDD node GVDD0, and a second electrode connected to the second output node N2. A fourth transistor M04 includes a gate electrode connected to the first control node [Q(n)], a first electrode connected to the second output node N2, and a second electrode connected to the second VSS node GVSS0.

The fifth transistor M05 includes a gate electrode connected to the first control node [Q(n)], a first electrode connected to the first VDD node GVDD1, and a second electrode connected to the third output node N3. The second capacitor C2 is connected between the first control node [Q(n)] and the third output node N3. The sixth transistor M06 includes a gate electrode connected to the second control node [QB(n)], a first electrode connected to the third output node N3, and a second electrode connected to the first VSS node GVSS1.

As shown in FIGS. 12 to 14, a pulse of the first gate signal [OUT(n)] has the same phase as that of the first control node [Q(n)] and the carry signal [C(n)]. A pulse of the second gate signal [OUTB(n)] has an inverted phase of the pulse of the first gate signal [OUT(n)] and has the same phase as the voltage of the boosting node [NET1(n)] of the inverter circuit INV.

In FIG. 14, the first VDD node GVDD1 and the second VDD node GVDD0 are electrically isolated. This is to prevent voltage fluctuations caused by IR drops in the power line connected to the first VDD node GVDD1 from affecting the first and second gate signals [OUT(n) and OUTB(n)].

In FIG. 14, the first gate-on voltage VGH1 may be set to a voltage higher than the second gate-on voltage VGH2, that is, VGH1 > VGH2. Thus, the high voltage VGH2 of the shift clocks CLK1 and CLK2 is lower than the voltage VGH1 of the VDD nodes GVDD1 and GVDD0.

The first gate-off voltage VGL1 may be set to a voltage higher than the second gate-off voltage VGL2, that is, VGL1>VGL2. If the voltage VGL1 applied to the second VSS node GVSS0 is higher than the voltage VGL2 applied to the first VSS node GVSS1, the leakage current of the transistors M01 to M04 and M1 to M4 may be prevented by applying a reverse voltage to the gate-source of the pull-up transistors M01, M03, M1, M3 and the pull-down transistors M02, M04, M2, M4 in the off-state.

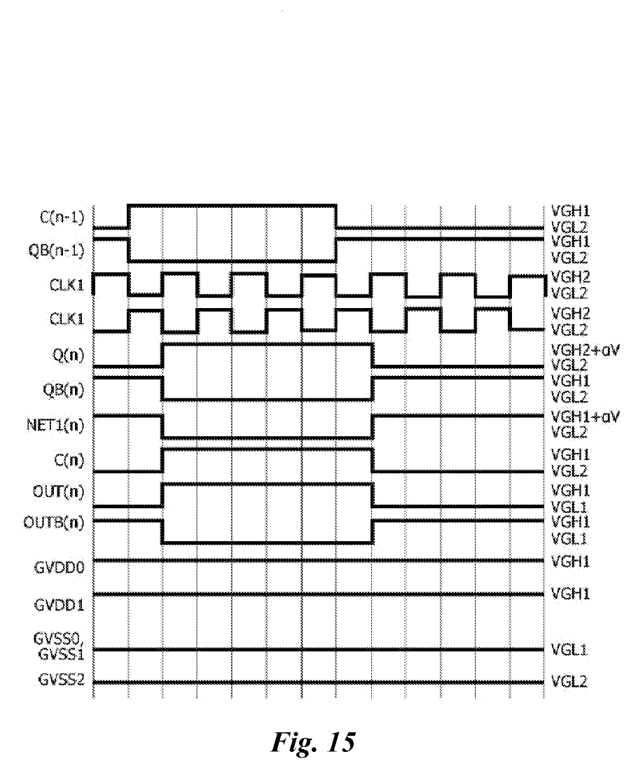

FIG. 15 is a waveform diagram illustrating input/output signals of the signal transmitter and the voltages of its major nodes when the inverter circuit shown in FIG. 12 and 13 is replaced with the inverter circuit shown in FIG. 5.

Referring to FIGS. 5, 12, 13, and 15, a voltage applied to the first VSS node GVSS1 connected to the inverter circuit INV and a low voltage of the gate signals [OUT(n) and OUTB(n)] outputted via the first and second output nodes N1 and N2 are the first gate off voltage VGL1. A voltage applied to the third VSS node GVSS2 connected to the inverter circuit INV, a low voltage of the carry signals [C(n-1) and C(n)] outputted via the third output node N3, a low voltage of the shift clocks CLK1 and CLK2, and a low voltage of the boosting node NET1 are the second gate-off voltage lower than the first gate-off voltage VGL1, that is VGL1>VGL2.

Pixels of an organic light-emitting display include a driving element for driving a light emitting element, and a pixel circuit including a capacitor connected to the driving element. Due to process deviations and device characteristic deviations resulting from the manufacturing process of the display panel, there may be differences in the electrical characteristics of the driving element for each pixel. These differences may increase as the driving time of the pixels elapses. In order to compensate for the differences in the electrical characteristics of the driving element for each pixel, an internal compensation circuit may be added to the pixel circuit. The internal compensation circuit may sample a threshold voltage of the driving element and compensate a gate voltage of the driving element by the amount of the threshold voltage of the driving elements.

FIG. 16 is a circuit diagram illustrating a pixel circuit according to one embodiment of the present disclosure. FIG. 17 is a waveform diagram illustrating waveforms of gate signals applied to the pixel circuit shown in FIG. 16. The pixel circuit illustrated in FIG. 16 includes an internal compensation circuit. The pixel circuit of the present disclosure is not limited to the circuit shown in FIG. 16.

Referring to FIGS. 16 and 17, the pixel circuit includes a light emitting element EL, a driving element DT driving the light emitting element EL, a plurality of switch elements NM1 to NM5, and a capacitor Cst. The driving element DT and the switch elements NM1 to NM5 may be implemented as n-channel oxide TFTs.

The pixel circuit is connected to a data line DL to which a data voltage Vdata is applied, and to gate lines GL1 to GL5 to which gate signals INIT, SENSE, SCAN, EM1, and EM2 are applied. The pixel circuit is connected to power nodes to which DC voltages (or constant voltages) are applied, such as a first constant voltage node PL1 to which a pixel driving voltage EVDD is applied, a second constant voltage node PL2 to which a cathode voltage EVSS is applied, a third constant voltage node PL3 to which an initialization voltage Vinit is applied, and a fourth constant voltage node PL4 to which a reference voltage Vref is applied. On the display panel 100, the power lines to which the constant voltage nodes are connected may be commonly connected to all pixels.

A voltage level of each of the constant voltages EVDD, EVSS, Vinit, and Vref applied to the pixel circuit may be set in consideration of the voltage margin for operation in the saturation region of the driving element DT. The voltage levels of the constant voltages EVDD, EVSS, Vinit, and Vref may be set in the condition of EVDD > Vref > Vinit > EVSS.

The gate signals INIT, SENSE, SCAN, EM1, and EM2 include pulses that swing between the gate-on voltage VGH and the gate-off voltage VGL. The gate-on voltage VGH may be set to a voltage level higher than the pixel drive voltage EVDD, and the gate-off voltage VGL may be set to a voltage level lower than the cathode voltage. In the examples of FIGS. 12 to 14, a voltage level of the gate-on voltage VGH is VGH1 and a voltage level of the gate-off voltage VGL is VGL1. The gate signals INIT, SENSE, SCAN, EM1, and EM2 include a first scan signal INIT, a second scan signal SENSE, a third scan signal SCAN, a first emission control signal (hereinafter referred to as “EM signal”) EM1, and a second EM signal EM2. The second scan signal SENSE may correspond to the first gate signal OUT in FIGS. 5 to 14, and the first EM signal EM1 may correspond to the second gate signal OUTB in FIGS. 5 to 14.

An operation period of the pixel circuit may be divided into an initialization period INI, a sensing period SEN, a data writing period WR, an anode reset period AR, and an emission period EMIS. The initialization period INI, the sense period SEN, the writing period WR, the anode reset period AR, and the emission period EMIS may be controlled by waveforms of the gate signals INIT, SENSE, SCAN, EM1, and EM2. A first margin period Isw may be set between the sensing period SEN and the data writing period WR, and a second margin period Iwa may be set between the data writing period WR and the anode reset period AR.

A voltage of the first scan signal INIT is generated as a pulse of the gate-on voltage VGH during the initialization period INI and the sensing period SEN, and is the gate-off voltage VGL during the other periods WR, AR, and EMIS. A first switch element NM1 is turned on in response to the gate-on voltage VGH of the first scan signal INIT and turned off according to the gate-off voltage VGL of the first scan signal INIT.

A voltage of the second scan signal SENSE is the gate-on voltage VGH at the beginning of the initialization period INI and the sensing period SEN, and is the gate-on voltage VGH during the anode reset period AR. The voltage of the second scan signal SENSE is inverted to the gate-off voltage VGL within the sensing period SEN and then inverted to the gate-on voltage VGH before the anode reset period AR. The voltage of the second scan signal SENSE is inverted to the gate-off voltage VGL at the beginning of the emission period EMIS. A second switch element NM2 is turned on in response to the gate-on voltage VGH of the second scan signal SENSE and turned off according to the gate-off voltage VGL of the second scan signal SENSE.

A voltage of the third scan signal SCAN is generated as a pulse of the gate-on voltage VGH synchronized with the data voltage Vdata of the pixel data during the data writing period WR, and is the gate-off voltage VGL during the other periods INI, SEN, AR, and EMIS. A third switch element NM3 is turned on in response to the gate-on voltage VGH of the third scan signal SCAN and turned off according to the gate-off voltage VGL of the third scan signal SCAN.

A pulse of the first EM signal EM1 has an inverted phase with respect to a pulse of the second gate signal OUTB. A voltage of the first EM signal EM1 is the gate-off voltage VGL at the beginning of the initialization period INI and the sensing period SEN, and is the gate-off voltage VGL during the anode reset period AR. The voltage of the first EM signal EM1 is inverted to the gate-on voltage VGH within the sensing period SEN and then inverted to the gate-off voltage VGL before the anode reset period AR. The voltage of the first EM signal EM1 is inverted to the gate-on voltage VGH at the beginning of the emission period EMIS. A fourth switch element NM4 is turned on in response to the gate-on voltage VGH of the first EM signal EM1 and turned off according to the gate-off voltage VGL of the first EM signal EM1.

A voltage of the second EM signal EM2 is the gate-on voltage VGH during the initialization period INI, the anode reset period AR, and the emission period EMIS, and is generated as a pulse of the gate-off voltage VGL during the sensing period SEN and the data writing period WR. A fifth switch element NM5 is turned on in response to the gate-on voltage VGH of the second EM signal EM2 and turned off according to the gate-off voltage VGL of the second EM signal EM2.

During the initialization period INI, the initialization voltage Vinit is applied to a second node n2 and the reference voltage Vref is applied to a third node n3 to initialize the capacitor Cst and a gate-source voltage Vgs of the driver element DT. During the sensing period SEN, a threshold voltage Vth of the driving element DT is sampled and stored in the capacitor Cst. During the data writing period WR, the data voltage Vdata is applied to the second node n2 so that the voltage charged on the capacitor Cst is changed to the data voltage Vdata compensated by the threshold voltage of the driving element DT. During the anode reset period AR, the reference voltage Vref is applied to the third node n3 and a fourth node n4 to suppress fluctuations in the gate-source voltage of the driving element DT in a low-speed driving mode. During the emission period EMIS, a current path is formed between the first constant voltage node PL1 and the second constant voltage node PL2, and the light emitting element EL is driven by the current generated by the gate-source voltage Vgs of the driving element DT. The light emitting element EL may be emitted according to the current from the driving element DT during the emission period EMIS.

The driving element DT generates a current according to a gate-source voltage Vgs to drive the light emitting element EL. The driving element DT includes a first electrode connected to a first node n1, a gate electrode connected to the second node n2, and a second electrode connected to the third node n3.

The light emitting element EL may be implemented as an OLED. The light emitting element EL includes an anode electrode, a cathode electrode, and an organic compound layer formed between the electrodes. The anode electrode of the light emitting element EL may be connected to a fourth node n4, and the cathode electrode is connected to the second constant voltage node PL2 to which the cathode voltage EVSS is applied. The organic compound layer may include, but not limited to, a hole injection layer HIL, a hole transport layer (HTL), an light emission layer (EML), an electron transport layer (ETL), and an electron injection layer (EIL). When a voltage is applied to the anode and cathode electrodes of the light emitting element EL, holes passing through the hole transport layer (HTL) and electrons passing through the electron transport layer (ETL) move to the emission layer (EML) to form excitons. In this case, visible light is emitted from the light emission layer EML. The light emitting element EL may be implemented as a tandem structure with a plurality of light emitting layers stacked on top of each other. The light emitting element EL having the tandem structure may improve the luminance and lifespan of pixels.

The capacitor Cst is connected between the second node n2 and the third node n3. The capacitor Cst is initialized in the initialization period INI and then stores the threshold voltage Vth of the driving element DT in the sensing period SEN. The capacitor Cst stores the data voltage Vdata of the pixel data compensated by the threshold voltage Vth of the driving element DT during the data writing period WR, and then maintains the gate-source voltage Vgs of the driving element DT during the anode reset period AR and the emission period EMIS.

A first switch element NM1 is connected between the third constant voltage node PL3, to which the initialization voltage Vinit is applied, and the second node n2, and is turned on in response to the gate-on voltage VGH of the first scan signal INIT. When the first switch element NM1 is turned on, the initialization voltage Vinit is applied to the second node n2. The first switch element NM1 is in the off state when the voltage of the first scan signal INIT is the gate-off voltage VGL. The first switch element NM1 includes a first electrode connected to the third constant voltage node PL3, a gate electrode connected to a first gate line GL1 to which the first scan signal INIT is applied, and a second electrode connected to the second node n2.

A second switch element NM2 is connected between the fourth constant voltage node PL4, to which the reference voltage Vref is applied, and the fourth node n4, and is turned on in response to the gate-on voltage VGH of the second scan signal SENSE. When the second switch element NM2 is turned on, the reference voltage Vref is applied to the fourth node n4. The second switch element NM2 is in the off state when the voltage of the second scan signal SENSE is the gate-off voltage VGL. The second switch element NM2 includes a first electrode connected to the fourth constant voltage node PL4, a gate electrode connected to a second gate line GL2 to which the second scan signal SENSE is applied, and a second electrode connected to the fourth node n4.

A third switch element NM3 is connected between the data line DL, to which the data voltage Vdata of pixel data is applied, and the second node n2, and is turned on in response to the gate-on voltage VGH of the third scan signal SCAN. When the third switch element NM3 is turned on, the data voltage Vdata is applied to the second node n2. The third switch element NM3 is in the off state when the voltage of the third scan signal SCAN is the gate off voltage VGL. The third switch element NM3 includes a first electrode connected to the data line DL, a gate electrode connected to a third gate line GL3 to which the third scan signal SCAN is applied, and a second electrode connected to the second node n2.

A fourth switch element NM4 is connected between the first constant voltage node PL1, to which the pixel drive voltage EVDD is applied, and the first node n1, and is turned on in response to the gate-on voltage VGH of the first EM signal EM1. When the fourth switch element NM4 is turned on, the pixel driving voltage EVDD is applied to the first node n1. The fourth switch element NM4 is in the off state when the voltage of the first EM signal EM1 is the gate off voltage VGL. The fourth switch element NM4 includes a first electrode connected to the first constant voltage node PL1, a gate electrode connected to a fourth gate line GL4 to which the first EM signal EM1 is applied, and a second electrode connected to the first node n1.

A fifth switch element NM5 is connected between the third node n3 and the fourth node n4 and is turned on in response to the gate-on voltage VGH of the second EM signal EM2. When the fifth switch element NM5 is turned on, the third node n3 is connected to the fourth node n4. The fifth switch element NM5 is in the off state when the voltage of the second EM signal EM2 is the gate-off voltage VGL. The fifth switch element NM5 includes a first electrode connected to the third node n3, a gate electrode connected to a fifth gate line GL5 to which the second EM signal EM2 is applied, and a second electrode connected to the fourth node n4.

The technical features to be achieved by the present disclosure, the means for achieving the technical features, and advantages and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure. The protective scope of the present disclosure should be construed based on the claims, and all the technical concepts in the equivalent scope thereof should be construed as falling within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A gate driving circuit comprising:
a plurality of signal transmitters,
wherein each of the signal transmitters includes:
an input circuit including a VST node and a CLK node, the VST node configured to receive a start pulse or a previous carry signal, and the CLK node configured to receive a clock, and the input circuit including an input buffer node;
an inverter circuit connected between a VDD node and a VSS node and including a first control node and a second control node, configured to cause the second control node to be at a logic low level during a charging period of the first control node when the first control node is at a logic high level, and to cause the second control node to be at the logic high level during a discharging period of the first control node when the first control node is at the logic low level, and the inverter circuit including a boosting node; and
a buffer circuit configured to output a first gate signal at a first output node and a carry signal at a third output node according to a voltage at the first control node and to output a second gate signal at a second output node according to a voltage at the second control node or a voltage at the boosting node.

2. The gate driving circuit of claim 1, wherein a second pulse of the second gate signal outputted at the second output node includes an opposite phase with respect to a first pulse of the first gate signal outputted at the first output node.

3. The gate driving circuit of claim 2, wherein a third pulse of the carry signal outputted at the third output node has a same phase as the first pulse of the first gate signal.

4. The gate driving circuit of claim 1, wherein the inverter circuit further includes:
a capacitor connected between the second control node and the boosting node, and
wherein a voltage of the boosting node is charged up to a level higher than a voltage of the VDD node when the second control node is at the logic high level.

5. The gate driving circuit of claim 4, wherein the inverter circuit further includes:
a first transistor connected between the VDD node and the boosting node and configured to supply a voltage applied to the VDD node to the boosting node;
a second transistor connected between the VDD node and the second control node and configured to be turned on when the boosting node is charged;
a third transistor connected between the boosting node and the VSS node and configured to be turned on when the first control node is at the logic high level; and
a fourth transistor connected between the second control node and a second VSS node and configured to be turned on when the first control node is at the logic high level.

6. The gate driving circuit of claim 4, wherein the inverter circuit further includes:
a first transistor connected between the VDD node and the boosting node and configured to be turned on when a second control node of a preceding signal transmitter is at a logic high level;
a second transistor connected between the VDD node and the second control node and configured to be turned on when the boosting node is charged;
a third transistor connected between the boosting node and the second control node and configured to be turned on when a voltage at the input buffer node is at a logic high level; and
a fourth transistor connected between the second control node and the VSS node and configured to be turned on when the input buffer node is at the logic high level.

7. The gate driving circuit of claim 5, wherein the buffer circuit includes:
a first transistor connected between a second VDD node and the first output node and configured to be turned on when the first control node is at the logic high level;
a second transistor connected between the first output node and the second VSS node and configured to be turned on when the second control node is at the logic high level;
a third transistor connected between the second VDD node and the second output node and configured to be turned on when the second control node is at the logic high level; and
a fourth transistor connected between the second output node and the second VSS node and configured to be turned on when the first control node is at the logic high level.

8. The gate driving circuit of claim 7, wherein the buffer circuit further includes:
a fifth transistor connected between the VDD node and the third output node and configured to be turned on when the first control node is at the logic high level;
a second capacitor connected between the first control node and the third output node; and
a sixth transistor connected between the third output node and the VSS node and configured to be turned on when the second control node is at the logic high level,
wherein:
the VDD node and the second VDD node are configured to receive a first gate-on voltage;
the VSS node is configured to receive a first gate-off voltage;
the second VSS node is configured to receive a second gate-off voltage that is higher than the first gate-off voltage; and
a logic high voltage of the clock is a second gate-on voltage that is lower than the first gate-on voltage.

9. The gate driving circuit of claim 5, wherein the buffer circuit includes:
a first transistor connected between a second VDD node and the first output node and configured to be turned on when the first control node is at the logic high level;
a second transistor connected between the first output node and the second VSS node and configured to be turned on when the second control node is at the logic high level;
a third transistor connected between the second VDD node and the second output node and configured to be turned on when the boosting node is charged; and
a fourth transistor connected between the second output node and the second VSS node and configured to be turned on when the first control node is at the logic high level.

10. The gate driving circuit of claim 9, wherein the buffer circuit further includes:
a fifth transistor connected between the VDD node and the third output node and configured to be turned on when the first control node is at the logic high level;
a second capacitor connected between the first control node and the third output node;
a sixth transistor connected between the third output node and the VSS node and configured to be turned on when the second control node is at the logic high level, and
wherein the VDD node and the second VDD node are configured to receive a first gate-on voltage;
the VSS node is configured to receive a first gate-off voltage;
the second VSS node is configured to receive a second gate-off voltage that is higher than the first gate-off voltage; and
a logic high voltage of the clock is a second gate-on voltage that is lower than the first gate-on voltage.

11. The gate driving circuit of claim 5, wherein the input circuit includes:
a fifth transistor connected between the VST node and the input buffer node and configured to be turned on when a voltage of the clock is at a logic high level;
a sixth transistor connected between the input buffer node and the first control node and configured to be turned on when the voltage of the clock is at the logic high level; and
a seventh transistor connected between the VDD node and the input buffer node and configured to be turned on when the first control node is at the logic high level.

12. A display device comprising:
a display panel in which a plurality of data lines, a plurality of gate lines, a plurality of power lines, a plurality of pixel circuits, and a gate driver to supply gate signals to the gate lines; and
a data driver configured to output a data voltage of pixel data to the data lines,
wherein the gate driver includes a plurality of signal transmitters,
each of the signal transmitters includes:
an input circuit including a VST node and a CLK node, the VST node configured to receive a start pulse or a previous carry signal, and the CLK node configured to receive a clock, and the input circuit including an input buffer node;
an inverter circuit connected between a VDD node and a VSS node and including a first control node and a second control node, configured to cause the second control node to be at a logic low level during a charging period of the first control node when the first control node is at a logic high level, and to cause the second control node to be at the logic high level during a discharging period of the first control node when the first control node is at the logic low level, and the inverter circuit including a boosting node; and
a buffer circuit configured to output a first gate signal at a first output node and a carry signal at a third output node according to a voltage at the first control node and to output a second gate signal at a second output node according to a voltage at the second control node or a voltage at the boosting node

13. The display device of claim 12, wherein a second pulse of the second gate signal outputted at the second output node includes an opposite phase with respect to a first pulse of the first gate signal outputted at the first output node; and
a third pulse of the carry signal outputted at the third output node has a same phase as the first pulse of the first gate signal.

14. The display device of claim 12, wherein the inverter circuit further includes:
a first transistor connected between the VDD node and the boosting node and configured to supply a voltage applied to the VDD node to the boosting node;
a second transistor connected between the VDD node and the second control node and configured to be turned on when the boosting node is charged;
a third transistor connected between the boosting node and the VSS node and configured to be turned on when the first control node is at the logic high level;
a fourth transistor connected between the second control node and the second VSS node and configured to be turned on when the first control node is at the logic high level; and
a capacitor connected between the second control node and the boosting node, and
wherein a voltage of the boosting node is charged up to a voltage higher than a voltage of the VDD node when the second control node is at the logic high level.

15. The display device of claim 12, wherein the inverter circuit further includes:
a first transistor connected between the VDD node and the boosting node and configured to be turned on when a second control node of a preceding signal transmitter is at a logic high level; and
a second transistor connected between the VDD node and the second control node and configured to be turned on when the boosting node is charged;
a third transistor connected between the boosting node and the second control node and turned on when a voltage at the input buffer node is at a logic high level;
a fourth transistor connected between the second control node and the VSS node and configured to be turned on when the voltage at the input buffer node is at the logic high level;
a capacitor connected between the second control node and the boosting node, and
wherein a voltage of the boosting node is charged up to a voltage higher than a voltage of the VDD node when the second control node is at the logic high level.

16. The display device of claim 14, wherein the buffer circuit includes:
a first transistor connected between a second VDD node and the first output node and configured to be turned on when the first control node is at the logic high level;
a second transistor connected between the first output node and the second VSS node and configured to be turned on when the second control node is at the logic high level;
a third transistor connected between the second VDD node and the second output node and configured to be turned on when the second control node is charged;
a fourth transistor connected between the second output node and the second VSS node and configured to be turned on when the first control node is at the logic high level;
a fifth transistor connected between the VDD node and the third output node and configured to be turned on when the first control node is at the logic high level;
a second capacitor connected between the first control node and the third output node; and
a sixth transistor connected between the third output node and the VSS node and configured to be turned on when the second control node is at the logic high level.

17. The display device of claim 14, wherein the buffer circuit includes:
a first transistor connected between a second VDD node and the first output node and configured to be turned on when the first control node is at the logic high level;
a second transistor connected between the first output node and a second VSS node and configured to be turned on when the second control node is at the logic high level;
a third transistor connected between the second VDD node and the second output node and configured to be turned on when the boosting node is charged;
a fourth transistor connected between the second output node and the second VSS node and configured to be turned on when the first control node is at the logic high level;
a fifth transistor connected between the VDD node and the third output node and configured to be turned on when the first control node is at the logic high level;
a second capacitor connected between the first control node and the third output node; and
a sixth transistor connected between the third output node and the VSS node and configured to be turned on when the second control node is at the logic high level.

18. The display device of claim 14, wherein the input circuit includes:
a fifth transistor connected between the VST node and the input buffer node and configured to be turned on when a voltage of the clock is at a logic high level;
a sixth transistor connected between the input buffer node and the first control node and configured to be turned on when the voltage of the clock is at the logic high level; and
a seventh transistor connected between the VDD node and the input buffer node and configured to be turned on when the first control node is at the logic high level.

19. The display device of claim 13, wherein the buffer circuit is connected to provide the first gate signal and the second gate signal to at least one of the pixel circuits.

20. A gate driving circuit comprising:
a plurality of signal transmitters,
wherein an nth signal transmitter of the plurality of signal transmitters includes:
an input circuit including a VST node and a CLK node, the VST node configured to receive a previous carry signal from an (n-1)th signal transmitter of the plurality of signal transmitters positioned previous to the nth transmitter, and the CLK node configured to receive a clock signal;
an inverter circuit coupled to the input circuit and including a first control node, a second control node, a boosting node, and a capacitor connected between the second control node and the boosting node, the first control node configured to have a first voltage, and the second control node configured to have a second voltage, the first voltage and the second voltage having opposite logic levels;
a buffer circuit configured to output a first gate signal at a first output node and an nth carry signal at a third output node based on the first voltage at the first control node and to output a second gate signal at a second output node based on the second voltage at the second control node or a voltage at the boosting node.
